(19) United States
(12) Patent Application Publication
(10) Pub. No.: US 2005/0244010 A1
(43) Pub. Date: Nov. 3, 2005

(54) Stereophonic sound reproducing system and stereophonic sound reproducing apparatus

(75) Inventors: Kenichi Kuwahara, Tokorozawa-shi (JP); Kei Sakagami, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/071,572

(22) Filed: Mar. 4, 2005

(30) Foreign Application Priority Data
Mar. 4, 2004 (JP) P2004-60065
Feb. 9, 2005 (JP) P2005-32641

(51) Int. Cl. H04R 5/00; H04R 5/02

(52) U.S. Cl. 381/18; 381/19; 381/307

(57) ABSTRACT

A stereophonic sound reproducing system including: a stereophonic sound reproducing device which provides a sound field space giving realistic sensations to a listener by publicly addressing sounds from speakers corresponding to inputted plural sound signals on the basis of the inputted plural sound signals; a main speaker which is arranged in a forward direction of the listener and publicly addresses the sound signal at a position which makes the listener include in an angle of sound spread; and a surround speaker which is arranged in a forward direction of the listener and publicly addresses the sound signal toward wall surfaces of the sound field space, wherein the stereophonic sound reproducing system includes: a signal adjustment device which adjusts the surround signal by adjusting frequency characteristics of a surround sound signal which represents the sound signal which inputted so as to be publicly addressed from the surround speaker on the basis of a propagation circumstance at the time of public address; a delay time addition device which adds a delay time corresponding to the surround sound signal which is publicly addressed from the surround speaker to a main signal representing the inputted sound signal which is publicly addressed from the main speaker; and an output device which outputs the main signal with the delay time added to the main speaker and outputs the surround sound signal with the frequency characteristics adjusted to the surround sound speaker.

### BACKGROUND OF THE INVENTION

1. Field of the Invention

The present invention relates to a technical field of a stereophonic sound reproducing apparatus which performs a stereophonic reproduction for creating realistic sensations.

2. Related Art

In recent years, a surround sound system for publicly addressing sounds such as voice and music are practically put into practical use by assigning a role of reproducing sound to a plurality of speakers such as a center speaker, right and left speakers, and right and left surround sound speakers, by adding a reverb sound to each speaker and by changing frequency characteristics.

Such a sound system is disclosed for example Japanese Unexamined Patent Publication No. JP-A-62-269599, which is incorporated by reference. As a representative example, a Dolby™ Digital 5.1 ch (channel) surround sound system is known.

However, in the conventional surround sound system, it is necessary to connect each speaker to an audio output device such as an AV amplifier. Especially, the surround sound speaker has a longer connection code because it is located in a side or a back of a listener. Further, in a sound field where a surround sound system is provided, there is a case where a surround sound speaker cannot be located on a side or back of the listener.

### SUMMARY OF THE INVENTION

The present invention is provided in view of the above problems and to provide, as one of the objects, a surround sound reproducing system which can easily create a sound field demonstrating a high realistic sensation by arranging a speaker which is arranged on the side or the back to the front of a listener in addition to a front speaker.

The present invention is provided to solve the above problems.

According to a first aspect of the present invention, there is provided a stereophonic sound reproducing system comprising:
a stereophonic sound reproducing device which provides a sound field space giving realistic sensations to a listener by publicly addressing sounds from speakers corresponding to inputted plural sound signals on the basis of the inputted plural sound signals;
a main speaker which is arranged in a forward direction of the listener and publicly addresses the sound signal at a position which makes the listener include in an angle of sound spread; and
a surround speaker which is arranged in a forward direction of the listener and publicly addresses the sound signal toward wall surfaces of the sound field space, wherein
the stereophonic sound reproducing system includes:
a signal adjustment device which adjusts the surround signal by adjusting frequency characteristics of a surround sound signal which represents the sound signal which inputted so as to be publicly addressed from the surround speaker on the basis of a propagation circumstance at the time of public address;
a delay time addition device which adds a delay time corresponding to the surround sound signal which is publicly addressed from the surround speaker to a main signal representing the inputted sound signal which is publicly addressed from the main speaker; and
an output device which outputs the main signal with the delay time added to the main speaker and outputs the surround sound signal with the frequency characteristics adjusted to the surround sound speaker.

According to a second aspect of the present invention, there is provided a stereophonic sound reproducing system according to the above aspect, wherein
the delay time addition device adds the delay time corresponding to a propagation route from the surround sound speaker through the wall surfaces to the listener at the time of publicly addressing the surround sound signal from the surround sound speaker.

According to a third aspect of the present invention, there is provided a stereophonic sound reproducing system according to the above aspect, wherein
the signal adjustment device adjusts the frequency characteristics of the surround sound signal on the basis of the propagation circumstance from the surround sound speaker through the wall surfaces to the listener at the time of publicly addressing the surround sound signal from the surround sound speaker.

According to a fourth aspect of the present invention, there is provided a stereophonic sound reproducing system according to the above aspect, wherein
the signal adjustment device adjusts the frequency characteristics of the frequency of the surround sound signal which is attenuated to be a predetermined level by reflection on the wall surfaces.

According to a fifth aspect of the present invention, there is provided a stereophonic sound reproducing system according to the above aspect, wherein
the signal adjustment device superposes a reverb sound component on the surround sound signal on the basis of the surround sound signal.

According to a sixth aspect of the present invention, there is provided a stereophonic sound reproducing system according to the above aspect, wherein
the surround sound speaker publicly addresses the surround sound signal toward at least any one of a side surface, a front surface, and an upper surface with respect to the listener within the sound field space.

According to a seventh aspect of the present invention, there is provided a stereophonic sound reproducing system according to the above aspect, wherein
the number of the surround sound speakers is two and the surround sound speakers are respectively arranged on the right side and the left side with respect to the listener, and
the surround sound speakers publicly addresses respectively toward different surfaces of the side wall surfaces.

According to an eighth aspect of the present invention, there is provided a stereophonic sound reproducing system according to the above aspect, wherein
when the stereophonic sound reproducing device makes the plural surround sound speakers publicly address, and the surround sound signals are subjected to a predetermined processing respectively for the surround sound speakers, the signal adjustment device superposes at least any one of a surround sound signal having a component different from that of the surround sound signal to be adjusted and a surround sound signal for publicly addressing from the surround sound speaker which is different from the surround sound speaker to be adjusted respectively on the surround sound signals to be adjusted.

According to a ninth aspect of the present invention, there is provided a stereophonic sound reproducing system according to the above aspect, wherein
the signal adjustment device superposes at least any one of the surround sound signal having a component different from that of the surround sound signal to be adjusted and the surround sound signal for publicly addressing from the surround sound speaker which is different from the surround sound speaker to be adjusted on each of the surround sound signals to be adjusted while adjusting the frequency characteristics of the frequency in the surround sound signal to be attenuated to a predetermined level by the reflection on the wall surface.

According to a tenth aspect of the present invention, there is provided a stereophonic sound reproducing system according to the above aspect, wherein
the signal adjustment device superposes at least any one of the surround sound signal having a component different from that of the surround sound signal to be adjusted and the surround sound signal for publicly addressing from the surround sound speaker which is different from the surround sound speaker to be adjusted on each of the surround sound signals to be adjusted while adjusting at least one of the surround sound signal to be adjusted and the surround sound signal having a component different from that of the surround sound signals to be adjusted.

According to an eleventh aspect of the present invention, there is provided a stereophonic sound reproducing system according to the above aspect, wherein
the signal adjustment device superposes at least any one of the surround sound signal having a component different from that of the surround sound signals to be adjusted and the surround sound signal for publicly addressing from the surround sound speaker which is different from the surround sound speaker to be adjusted on each of the surround sound signals to be adjusted while adding a reverb sound component on the basis of the surround sound signals.

According to a twelfth aspect of the present invention, there is provided a stereophonic sound reproducing system according to the above aspect, wherein
the signal adjustment device superposes the surround sound signals which are generated by adding each of the surround sound signals respectively to the surround sound signals.

According to a thirteenth aspect of the present invention, there is provided a stereophonic sound reproducing device for providing a sound field space giving realistic sensations to a listener by publicly addressing sounds from speakers corresponding to inputted plural sound signals on the basis of the inputted plural sound signals comprising, in publicly addressing from a main speaker which is arranged in a forward direction of the listener and publicly addresses the sound signal at a position which makes the listener include in an angle of sound spread and also from a surround speaker which is arranged in a forward direction of the listener and publicly addresses the sound signal toward wall surfaces of the sound field space:
a signal adjustment device which adjusts a surround sound signal by adjusting frequency characteristics of the surround sound signal which represents a sound signal inputted to be publicly addressed from the surround sound speaker on the basis of a propagation circumstance at the time of public address;
a delay time addition device which adds a delay time corresponding to the surround sound signal which is publicly addressed from the surround speaker to a main signal representing the inputted sound signal which is publicly addressed from the main speaker; and
an output device which outputs the main signal with the delay time added to the main speaker and outputs the surround sound signal with the frequency characteristics adjusted to the surround sound speaker.

### BRIEF DESCRIPTION OF THE DRAWINGS

In the accompanying drawings:

FIG. 1 is a block chart for showing a structure of a surround sound system according to a first embodiment of the present invention;

FIG. 2 shows an example for explaining speaker arrangement in the surround sound system according to the first embodiment;

FIG. 3 is to explain a sound propagation route of a sound publicly addressed by the speakers according to Embodiment 1;

FIG. 4 is a block chart for showing a structure of a surround sound system according to Embodiment 2 of the present application;

FIG. 5 is a block chart for showing a structure of a surround sound signal processing unit according to Embodiment 2.

FIG. 6 is an example of filter characteristics presented by a filter processing unit according to Embodiment 2.

FIG. 7 is an example of a reverb component which is generated in a reverb generation circuit for surround sound according to Embodiment 2.

FIG. 8 is another example of a block chart for showing a structure of a surround sound signal processing unit according to Embodiment 2;

FIG. 9 is an example of a block chart for showing a structure of a surround sound signal processing unit according to Embodiment 3; and

FIG. 10 is another example of a block chart for showing a structure of a surround sound signal processing unit according to Embodiment 3.

### DESCRIPTION OF THE PREFERRED EMBODIMENTS

Preferred embodiments of the present invention will be described in conjunction with the figures. The below described embodiments are for a case where a STEREOPHONIC SOUND REPRODUCING SYSTEM or a STEREOPHONIC SOUND REPRODUCING APPARATUS is applied to a surround sound system of 5.1 ch (hereinafter referred to as a surround sound system).

Hereinafter, each meaning of the reference numbers in the drawings is as follows:
100, 200: SURROUND SOUND SYSTEM; 110: SOUND SOURCE OUTPUT DEVICE; 120, 220: SIGNAL PROCESSING DEVICE; 122: REVERB ADDITION CIRCUIT; 123: FREQUENCY CHARACTERISTICS CORRECTIONCIRCUIT; 124: DELAYCIRCUIT; 130: SPEAKERSYSTEM; 131: C (Center) SPEAKER; 132: FL (Front Left) SPEAKER; 133: FR (Front Right) SPEAKER; 134: SBL (Surround Sound Left) SPEAKER; 135: SBR (Surround Sound Right) SPEAKER; 136: SUB WOOFER; 300, 400 SURROUND SOUND SIGNAL PROCESSING UNIT; 310: FIRST INPUT DIVIDER; 320: SECOND INPUT DIVIDER; 330: INPUT ADDER; 340: FILTER PROCESSING UNIT; 350: REVERB GENERATION CIRCUIT FOR SURROUND SOUND; 360: OUTPUT DIVIDER; 370: FIRST OUTPUT ADDER; 380: SECOND OUTPUT ADDER; 410: FIRST OUTPUT DIVIDER; and 420: SECOND OUTPUT DIVIDER.

### Embodiment 1

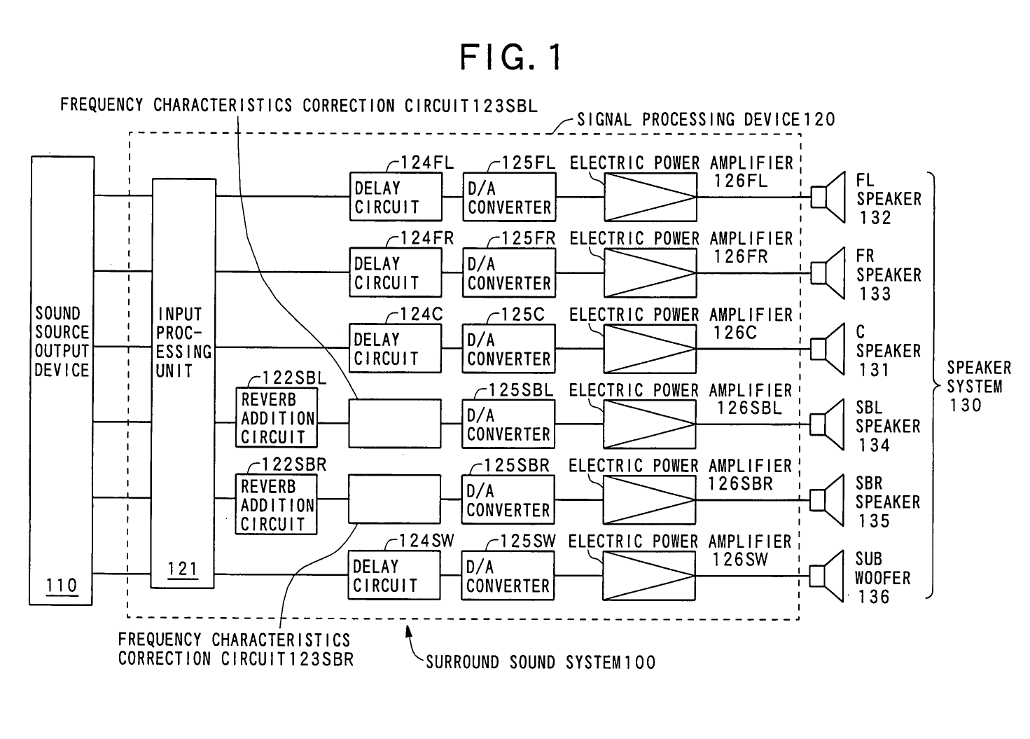

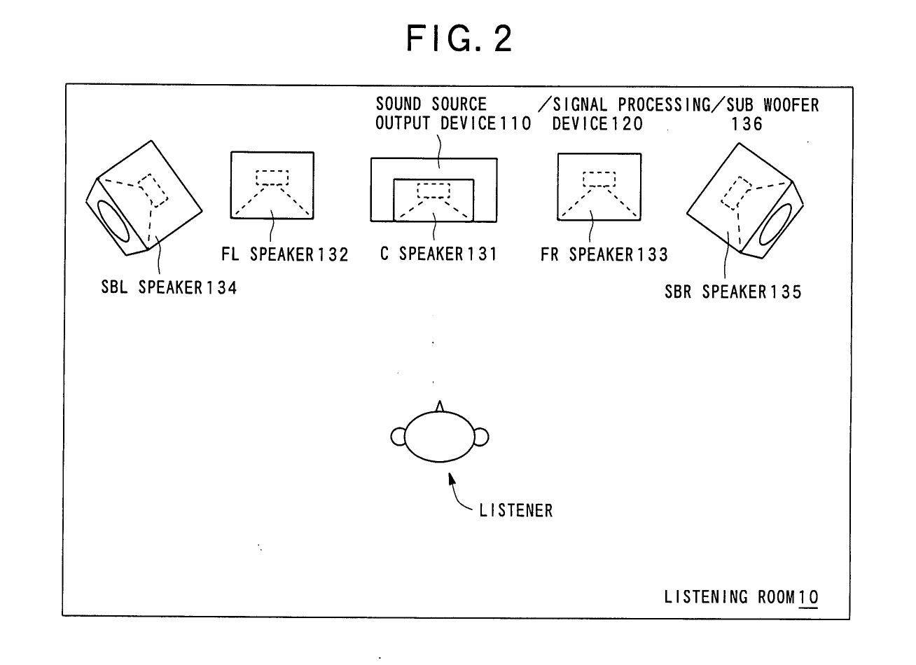

First, a surround sound system according to Embodiment 1 of the present invention will be described 10 in reference of FIGS. 1 and 2. FIG. 1 is a block chart for showing a structure of a surround sound system according to this embodiment of the present invention, and FIG. 2 is an example for explaining speaker arrangement in the surround sound system according to the first embodiment.

As shown in FIG. 1, the surround sound system according to this embodiment is located in a listening room 10, i.e. a sound space for providing a reproduced sound to a listener, in which a sound source is reproduced or acquired, and a predetermined signal process is conducted with respect to the reproduced sound or the acquired sound. The surround sound system 100 publicly addresses a sound subjected to a signal processing speaker by speaker in a speaker system 130 which includes a plurality of speakers, and thereby provides a sound space which serves realistic sensations (a feeling of sound surrounding) to a listener.

The surround sound system 100 is made up of a sound source output device 110 which outputs audio signals related to channels corresponding to speakers by obtaining a sound source such as a recording medium or obtaining a sound source from an outside such as a television signal, a signal processing device 120 which receives signals of the plurality of channels that are outputted from the sound source output device 110 and conducting a signal processing channel by channel, and a speaker system 130 which is made up of various speakers corresponding to the channels.

The channel is a signal propagation route of an audio signal which is outputted from the sound source output device 110. The channels basically propagate an audio signal respectively different from the other channels.

The sound source output device 110 is made up of for example a media reproduction device such as a compact disk (CD) or a digital versatile disk (DVD) or a receiving device for receiving digital television broadcast. The sound source output device 110 reproduces the sound source such as a CD or acquires a broadcasted sound source and outputs audio signals respectively corresponding to the channels of 5.1 ch as digital signals.

The signal processing device 120 receives the audio signals which are outputted from the sound source output device 110 for each channel. The signal processing device 120 adds a delay time to the received audio signals for each channel, adds a reverb component, and adjusts each frequency component to adjust a signal level in converting thus signal-processed audio signals to analogue signals. The signal processing device 120 outputs the audio signals subjected to the signal level adjustment to speakers of the speaker system 130.

The structure and a detailed operation of the signal processing device 120 according to this embodiment will be described later.

The speaker system 130 is made up of a center speaker 131 (hereinafter referred to as a C speaker), a front left speaker 132 (hereinafter referred to as a FL speaker) and a front right speaker 133 (hereinafter referred to as a FR speaker) which are arranged on a front side of the listener and respectively on a right or left side of the C speaker 131, a surround sound left speaker 134 (hereinafter referred to as an SBL speaker) and a surround sound right speaker 135 (hereinafter referred to as an SBR speaker) which are arranged on a front side of the listener and respectively on a right side the FL speaker 132 or a left side of the FR speaker 133, and a low range reproduction speaker 136 (hereinafter referred to as a sub woofer) which is arranged at an arbitrary position for example as shown in FIG. 2.

Each speaker in the speaker system 130 according to this embodiment, especially arrangement of the SBL speaker 134 and the SBR speaker 135, will be described later.

Next, the structure and the operation of the signal processing device 120 according to this embodiment is described.

As shown in FIG. 1, the signal processing device 120 of this embodiment includes an input processing unit 121 which inputs audio signals for each channel, processes a predetermined input process, and outputs the audio signals for each channel, a reverb addition circuit 122 which adds a reverb component to audio signals (hereinafter referred to as a surround sound signal) of the channels corresponding to the SBL speaker 134 and the SBR speaker 135, and a frequency characteristics correction circuit 123 which corrects the frequency characteristics with respect to each of the surround sound signals.

The signal processing device 120 includes a delay circuit 124 for appending a delay time to the audio signals (hereinafter referred to as a main signal) of the channels corresponding to the C speaker 131, the FL speaker 132, and the FR speaker 133, and a delay time to the audio signal (hereinafter referred to as a woofer signal) corresponding to the sub woofer 136, a D/A converter 125 for conducting a digital/analogue (hereinafter referred to as D/A) conversion to the audio signals of the channels, and an electric power amplifier 126 for amplifying channel by channel signal levels of signals from the channels.

For example, the reverb addition circuit 122 according to this embodiment forms a signal adjustment device according to the present invention, and the frequency characteristics correction circuit 123 forms the signal adjustment device according to the present invention. Further, for example, the delay circuit 124 according to this embodiment forms the delay time addition circuit according to the present invention, and the electric power amplifier 126 according to this embodiment forms an output device according to the present invention.

The input processing unit 121 inputs the audio signals outputted from the sound source output device 110. The input processing unit 121 outputs thus inputted audio signals to the reverb addition circuit 122 or the delay circuit 124, which respectively correspond to the channels.

The reverb addition circuit 122 inputs the surround sound signals corresponding to the channels. Each of the reverb addition circuit 122 generates components of reverb sound respectively of the surround sound signals (hereinafter referred to as a reverb component) based on the inputted surround sound signals, and adds the reverb component respectively of the surround sound signals thus generated to the inputted surround sound signals. The reverb addition circuits 122 respectively output the surround sound signals with the reverb components added to the frequency characteristics correction circuits 123.

The frequency characteristics correction circuits 123 respectively input the surround sound signals which are respectively outputted from the reverb addition circuits 122, and the frequency characteristics correction circuits 123 adjust frequency characteristics of the inputted surround sound signals and respectively output the adjusted surround sound signal to the D/A converters 125. Specifically, in this embodiment, the frequency characteristics correction circuits 123 amplify sound levels of the frequency components of the inputted signals in high range.

Ordinarily, when a surround sound signal is publicly addressed from surround sound speakers to a wall surface of a sound field space, a high frequency component of the surround sound signal thus publicly addressed may be attenuated when it reaches a listener depending on a reflection property of the wall of the sound field space. In this case, a propagation circumstance of the sound field space is what attenuating a high frequency component of the surround sound signal. Therefore, in this embodiment, by amplifying the signal level of the high frequency components of the publicly addressed surround sound signals, it is possible to decrease an influence of the publicly addressed sound, which is caused depending on the propagation circumstance.

For example, when a sound reflects on a wall surface, in terms of frequency characteristic, it ordinarily attenuates in a frequency of 1 kHz or more and does so about −10 dB in a frequency of 5 kHz or more. In the present invention, by amplifying about 5 dB with respect to a frequency of 1 kHz or more, an influence on the frequency characteristic of a publicly addressed sound on the basis of a propagation circumstance.

Various main signals and woofer signals are respectively inputted into the delay circuits 124. The delay circuits 124 add a delay time corresponding to a propagation route to a listener through a wall surface of a sound field space in publicly addressing a surround sound signal, and the added signals are respectively outputted to the D/A converters 125.

Ordinarily, when a sound field space serving realistic sensations are provided, no delay time is added to the main signal and the woofer signal which signals are main portions of the publicly addressed sound. However, in this embodiment, since the surround sound speakers publicly address sounds toward the wall surfaces of the sound field space, i.e. the surround sound signal is indirectly listened by a listener not directly, the propagation route distance of the publicly addressed sound from the surround speaker becomes longer than the publicly addressed signal of the main signal of the C speaker 131, the FL speaker 132, and the FR speaker 133, whereby the listener may feel a time difference at his position. Therefore, in this embodiment, the delay time is added in consideration of the propagation route of the surround sound signal with respect to the main signal and the woofer signal in order to avoid generation of the time difference between the publicly addressed sound in the surround sound signal and the publicly addressed sound in the main signal at the listener's position.

Meanwhile, because a sound field space such as an ordinary listening room has a wall surface of a ceiling and the height is around 2 to 3 meters, distance differences of propagation routes depending on the height of the ceiling scarcely affect delay time differences. In this embodiment, a delay time which is obtained in advance from test data is stored inside the delay circuits 124 so that the delay time is added to the main signal and the woofer signal.

The main signal, the surround sound signal, and the woofer signal, which have been subjected to the signal processing channel by channel, are respectively inputted into the D/A converters 125. The D/A converters 125 respectively output the signals of the inputted digital signals respectively to the electric power amplifiers 126 after converting the signals to analogue signals.

The electric power amplifiers 126 input the audio signals which have been subjected to signal processing channel by channel. The electric power amplifiers 126 amplifies the signal levels of the inputted audio signals channel by channel under control of a system control unit, and the amplified audio signals are outputted to the speakers respectively corresponding to the channels.

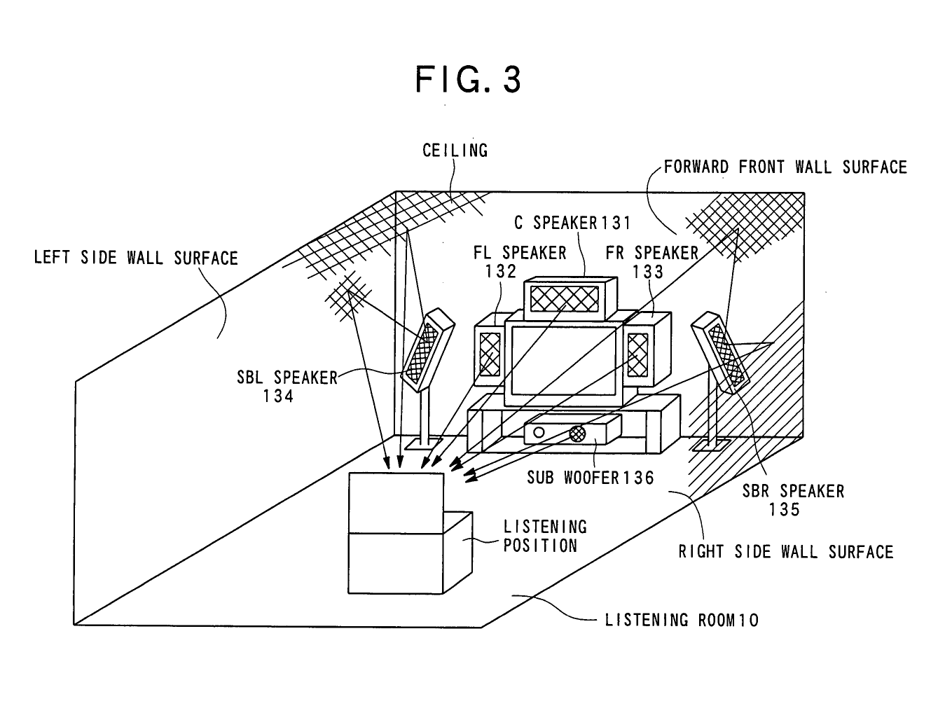

Next, the speakers according to this embodiment will be described in reference of FIG. 3 along with FIG. 2. FIG. 3 is prepared for explaining a propagation route of sound which has been publicly addressed by the speakers of this embodiment.

The speaker system 130 is arranged for example as in FIG. 2. The C speaker 131 is arranged in a forward front of a listener. The FL speaker 132 and the FR speaker 133 are arranged respectively in a left forward position or a right forward position of the listener and respectively on a left side and a right side of the C speaker 131. The SBL speaker 134 and the SBR speaker 135 are arranged respectively in a left forward position or a right forward position of the listener and respectively on a left side of the FL speaker 132 and a right side of the FR speaker 133. The sub woofer 136 can be arranged at an arbitrary position.

For example, the C speaker 131, the FL speaker 132, and the FR speaker 133 form a main speaker of the present invention, and the SBL speaker 134 and the SBR speaker 135 form a surround speaker of the present invention.

The C speaker 131 is a full band type speaker which has a frequency characteristic of reproducing substantially full range of frequency bands in publicly addressing audio signals, and the signals are publicly addressed toward a listener so that an emission center axis directs the listener.

Meanwhile, although it is preferable that the emission center axis directs toward the listening position (listening point) of the listener, it is sufficient that the listener is located within an angle of sound spread of the C speaker 131.

The FL speaker 132 and the FR speaker 133 are formed by a full band type speaker which has a frequency characteristic of reproducing substantially full range of frequency bands in publicly addressing audio signals, and the signals are publicly addressed toward a listener so that an emission center axis directs the listener.

Although it is preferable that the emission center axes of the FL speaker 132 and the FR speaker 133 are arranged in parallel to an axis connecting the emission center axis of the C speaker 131 to the listening position of the listener, it is sufficient that the listener is located within angles of sound spread of the FL speaker 131 and the FR speaker 132.

The sub woofer 136 is formed by a speaker which has a frequency characteristic of reproducing only bass, for example, frequencies of several hundreds of Hz to several kilos of Hz and of which directional characteristic is essentially omnidirectional. Although the sub woofer 136 is arranged in the vicinity of the C speaker 131, since the direction characteristic is omnidirectional, the sub woofer can be arranged at an arbitrary position.

The SBL speaker 134 and the SBR speaker 135 are formed by a full band type speaker which has a frequency characteristic of reproducing substantially full range of frequency bands in publicly addressing audio signals in a similar manner to that in the C speaker 131. On the other hand, in this embodiment, the SBL speaker 134 and the SBR speaker 135 are arranged toward any one of wall surfaces in the side directions, the front direction, and the upward directions, and sound is publicly addressed through the wall to the listener.

Ordinarily, when the surround sound speaker is arranged in front of a listener, the surround sound speaker is arranged so that the emission center axis of the surround sound speaker directs toward the listener. In this case, the signal is processed so that the surround speaker is as if arranged on a side or a back of the listener by for example adding a reverb component, setting a sound image localization and correcting frequency characteristics.

However, when the surround sound signal is subjected to the signal processing as if the surround sound speaker is fictitiously arranged on the side or the back of the listener, the sound field space where sound field is reproduced is created by sounds that are publicly addressed from the front speakers and by a fictitious sound image that is generated by the surround sound speaker, whereby a direct sound mainly reaches the listener. As a result, the listener cannot expect a sufficient feeling of spreading and deepening, and therefore it is not possible to provide which provides the listener with a sound field giving high realistic sensations. Meanwhile, in this embodiment, since the publicly addressed sound from the surround sound speakers reaches the listener through the wall of the sound field space, it is possible to provide the publicly addressed sound related to the surround sound signal as an indirect sound. In other words, in this embodiment, the publicly addressed sound that is publicly addressed from the surround sound speakers is reflected on a side wall surface and a ceiling. Therefore, the sounds are reflected so as to surround the listener in this embodiment, a sound field bringing about highly realistic sensations can be created.

For example, in this embodiment, as shown in FIGS. 2 and 3, the SBL speaker 134 is arranged to direct its emission center axis toward the left side wall surface with respect to the listener, and the SBL speaker 134 itself is arranged to slant so that the emission center axis directs toward the ceiling. Also the SBR speaker 135 is arranged to direct its emission center axis toward the right side wall surface with respect to the listener, and the SBR speaker 135 itself is arranged to slant so that the emission center axis directs toward the ceiling.

Further, as shown in FIG. 3, the horizontal angles of the SBL speaker 134 and the SBR speaker 135 are preferably 40 to 70 degrees and the vertical angles thereof are preferably 20 to 50 degrees. In this, the horizontal angle means a rotational angle from a base (0 degree) of an axis connecting the emission center axis of the C speaker 131 and the listener toward each of the side wall directions, and the vertical angle means a rotational angle from a base (0 degree) of an axis in parallel to the emission center axis on the bottom surface toward the ceiling surface.

As described, the surround sound system 100 according to this embodiment includes the signal processing device 120 which provides a sound field space giving realistic sensations to the listener by publicly addressing the speakers corresponding to the audio signals based on a plurality of inputted audio signals, the C speaker 131 which is arranged in a forward direction of the listener and publicly addresses the audio signal at a position where the listener is located within the angle of sound spread, the FL speaker 132, the FR speaker 133, the SBL speaker 134 and the SBR speaker 135 both of which publicly address the audio signal to the wall surfaces of the sound field space. The signal processing device 120 has a structure that includes the input processing unit 121 which inputs the main signal and the surround sound signal, the frequency characteristics correction circuit 123 which adjusts the frequency characteristics of the inputted surround sound signal based on the propagation circumstance at the time of publicly addressing the surround sound signal, the delay circuit 124 which adds the delay time corresponding to the surround sound signal to the inputted main signal, the electric power amplifier 126 which outputs the main signal having the delay time added to the C speaker, the FL speaker 132 and the FR speaker 133, and outputs the surround sound signal of which frequency characteristics are adjusted to the SBL speaker 134 and the SBR speaker 135.

According to this structure, in the surround sound system 100 according to this embodiment, the delay time which is caused when the surround sound signal is publicly addressed to reach the listener is added to the inputted main signal, and the main signal with the delay time added is outputted to the C speaker 131, the FL speaker 132, and the FR speaker 133 which publicly address the audio signal at a position where the listener is located within the angle of sound spread. At the same time, the frequency characteristics of the inputted surround sound signal are adjusted, and the surround sound signal with the frequency characteristics adjusted is outputted to the SBL speaker 134 and the SBR speaker 135 which publicly address the sound toward the wall surfaces of the sound field space.

Accordingly, in the surround sound system 100, the surround sound speaker can be placed on the front side of the listener. Therefore, even though the surround speaker cannot be placed on the back side of the listener in the sound field space, the surround speaker can be utilized and it is unnecessary to use a longer connection code for wiring or the like to reach the surround sound speaker placed on the back side of the listener.

Further, the surround sound system 100 can provide the surround sound signal to the listener as an indirect sound. Because the main signal can be presented after delaying the main signal based on the indirect sound at the time of providing the surround sound signal as the indirect sound, the publicly addressed sound which are presented into the sound field space does not create a feeling of strangeness, the realistic sensations can be easily created, and it is possible to provide a sound field space causing a sufficient feeling of spreading and deepening to the listener.

Incidentally, although the delay circuit 124 adds a predetermined delay time, it is possible to allow the listener to input the size of the sound field space, i.e. a listening room, from an operation unit to thereby set a delay time depending on the inputted size of the listening room and add thus set delay time to the main signal and the woofer signal.

In this case, the delay times respectively corresponding to the sizes are stored inside the delay circuits 124 in advance.

Further, although the surround sound system according to this embodiment is configured to reflect the publicly addressed sound from the surround sound speakers on the side wall surface and the ceiling surface of the sound field space, it can be reflected on also the front wall surface of the listener.

### Embodiment 2

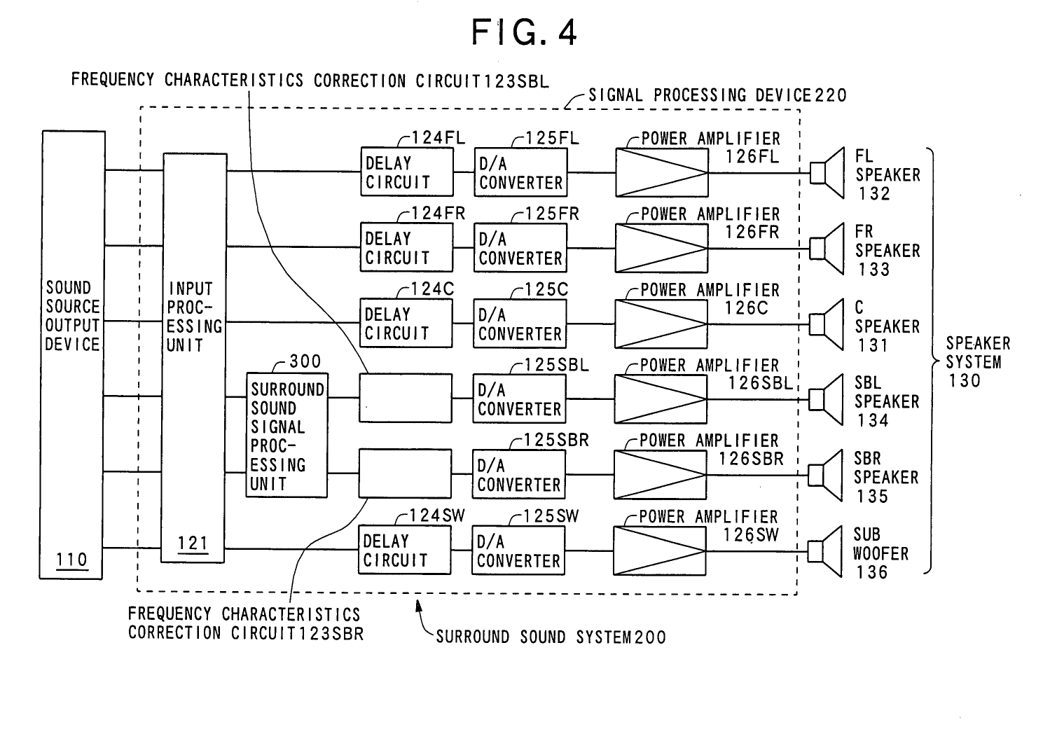

The surround sound system according to Embodiment 2 will be described in reference of FIGS. 4 to 8. This embodiment has a characteristic that a reverb component is added to the surround sound signal while adding a monaural signal corresponding to the surround sound signal to thereby reduce non-correlation of the surround sound signal instead of independently adding a reverb component to each surround sound signal in Embodiment 1.

In this embodiment, the other portions of the structure are similar to those of Embodiment 1. Therefore, the same numerical references are used for the same or similar portions and descriptions of these portions are omitted.

First, a structure of a surround sound system according to this Embodiment. FIG. 4 is a block chart for showing the structure of the surround sound system according to Embodiment 2 of the present invention.

As shown in FIG. 4, the surround sound system according to this embodiment is made up of a sound source output device 110, a signal processing device 220 which inputs signals of a plurality of channels which signals are outputted from the sound source output device 110 and conduct signal processing channel by channel, and a speaker system 130 including various speakers corresponding to the channels. Especially, the signal processing device 220 according to this embodiment generates a surround sound signal of a monaural type (hereinafter referred to as a monaural signal) based on the surround sound signals of a stereo type so that the signal processing of adding a reverb component to the generated monaural signal and adding the monaural signals respectively to the surround sound signal.

Specifically, the signal processing device 220 according to this embodiment includes an input processing unit 121, a frequency characteristics correction circuit 123, a delay circuit 124, a D/A converter 125, an electric power amplifier 126, and a surround sound signal processing unit for conducting the above signal processing to surround sound signals corresponding to an SBL speaker 134 and an SBR speaker 135.

For example, the frequency characteristics correction circuit 123 and the surround sound signal processing unit 300 constitute a signal adjustment device according to this invention. For example, the delay circuit 124 constitutes a delay time addition circuit according to the present invention. For example, the electric power amplifier 126 constitutes an output device according to the present invention.

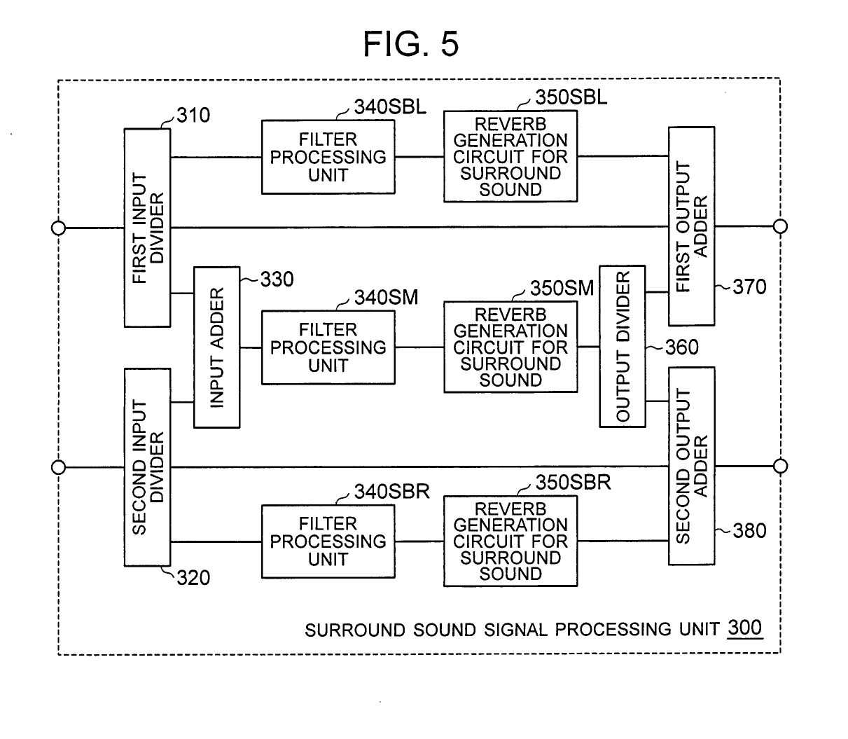

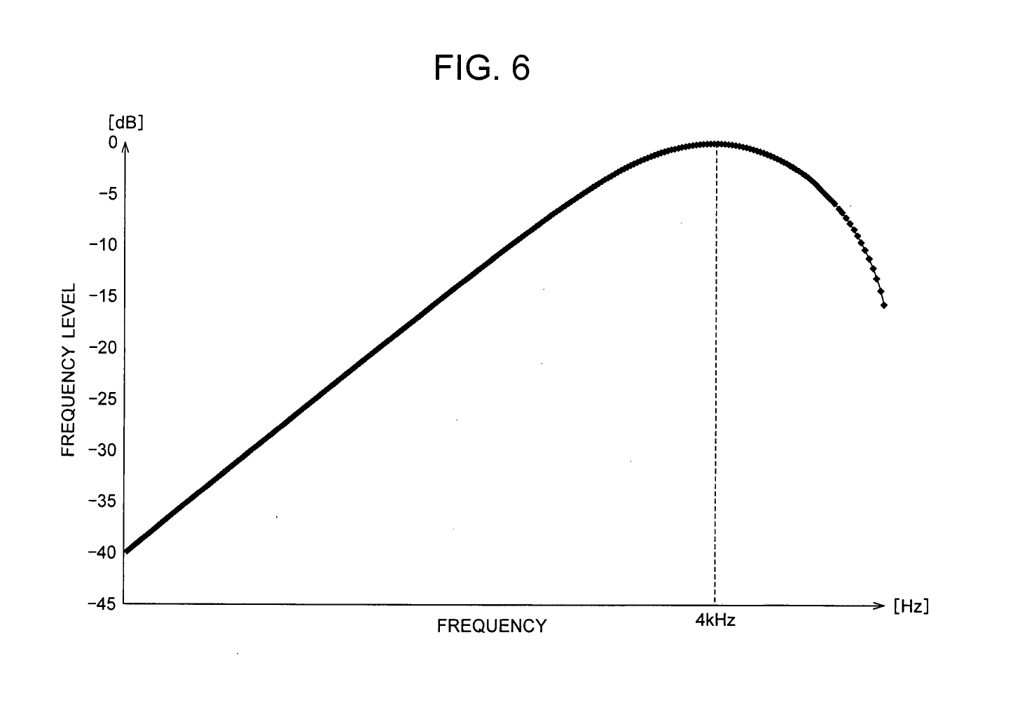

Next, a structure and an operation of the surround sound signal processing unit 300 will be described in reference of FIGS. 5 and 6.

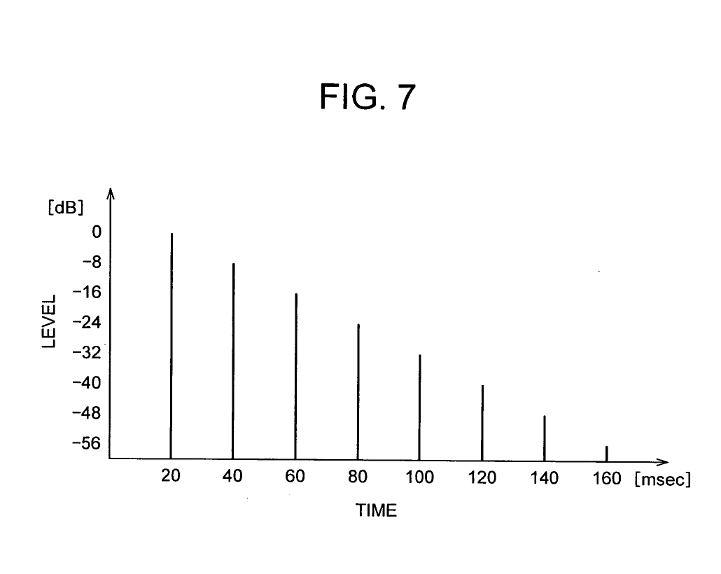

FIG. 5 is a block chart for showing the structure of the surround sound signal processing unit 300 according to this embodiment. FIG. 6 is an example of filter characteristics provided in the filter processing unit 340 this embodiment. FIG. 7 is an example of a reverb component generated in a reverb generation circuit for surround sound 350.

In the surround sound signal processing unit 300 according to this embodiment, various surround sound signals are respectively inputted thereinto, and the surround sound signal processing unit 300 generates a monaural signal based on the inputted various surround sound signals to respectively add the reverb component the inputted surround sound signal and superpose the generated monaural signal thereto. In other words, the surround sound signal processing unit 300 superposes the surround sound signal of the monaural type in the surround sound signal to the surround sound signal of the stereo type for publicly addressing from the SBL speaker 134 and the SBR speaker 135 (hereinafter totally referred to as a surround speaker) to thereby reduce non-correlation in publicly addressed sound from the speakers to a listener.

Ordinarily, the monaural signal is publicly addressed from a speaker set in a front side of a listener and heard by the listener and directional perception of the listener with respect to the speaker in forward and backward directions is weak, in other words a perceptual psychological characteristic that it is difficult to know whether a sound is publicly addressed from a front side of a listener or a back side thereof is known.

The surround sound signal processing unit 300 works to spread the directional perception of the publicly addressed sound toward the back side of the listener by adding a monaural signal to a surround sound signal publicly addressed from surround sound speakers 134 and 135 which provide a surround effect to a ceiling surface and a side wall surface to decrease non-correlation of the publicly addressed sound.

Specifically, the surround sound signal processing unit 300 includes a first input divider 310 and a second input divider 320 which divide respectively inputted surround sound signal to plural numbers, an input adder 330 which generates a monaural signal, and filter processing units 340 which conduct signal processing with respect to the monaural signals.

The surround sound signal processing unit 300 includes a reverb generation circuit 350 for surround sound which generates a reverb component based on signals subjected to filter processing, an output divider 360 which divides a monaural signal generated as the reverb component, a first output adder 370 and a second output adder 380 respectively add the monaural signal which is divided and generated as the reverb component to the surround sound signal which is divided and the surround sound signal which is generated as the reverb component while adjusting it to be a predetermined signal level.

The first input divider 310 inputs the surround sound signal which is publicly addressed by an SBL speaker 134 which is outputted from the input processing unit 121. The first input divider 310 divides the inputted surround sound signal into three systems and respectively outputs to the input adder 330, the filter processing unit 340, and the first output adder 370.

Since the structure of the second input divider 320 is the same as that of the first input divider 310 except for the surround sound signal to be processed; description thereof is omitted.

The input adder 330 inputs the surround sound signals which are outputted from the first input divider 310 and the second input divider 320. The input adder 330 adjusts the signal levels of the surround sound signals to a predetermined signal level, adds the surround sound signals, and generates the monaural signal. The input adder 330 outputs the generated monaural signal to a corresponding filter processing unit 340.

For example, the input adder 330 adds the surround sound signals at a ratio of one to one, namely the inputted surround sound signals are adjusted to be in signal levels of 0.5 times thereof and added thereafter.

The filter processing units 340 respectively input the surround sound signals or the monaural signal. This embodiment conducts filter processing by applying a predetermined band pass filter through which a high frequency component is allowed to pass to the inputted surround sound signals or monaural signal, and the surround sound signals or monaural signal thus filter-processed are outputted to the reverb generation circuit for surround sound signal 350.

In this embodiment, as described above, the publicly addressed signal is reflected on a ceiling surface or a side wall surface when the surround sound signals are publicly addressed by the surround sound speakers 134 and 135. However, in this case, when the publicly addressed sound reaches the listener in use of the reflection characteristics by the wall surfaces, the high frequency component is attenuated when it reaches the listener. Therefore, in this embodiment, the influence of the frequency characteristic of the publicly addressed sound based on the propagation circumstance is relaxed by adding the signal level of the high frequency components to the publicly addressed surround sound signal.

For example, each of the filter processing units 340 uses a band pass filter having an amplitude characteristic of Q value=0.5 at a central frequency of 4 kHz as shown in FIG. 6.

The Q value is represented by the following formula, where f0 designates the maximum frequency in the frequency characteristic, and f1 and f2 respectively designate frequencies of being −3 dB of the maximum value on the both sides.
Q=f0/(f2−f1) (Formula 1)

Each of the reverb generation circuit for surround sound 350 inputs the surround sound signals and the monaural signal which are subjected to the filter processing. The reverb generation circuit for surround sound 350 generates a reverb component by adding a predetermined delay time to the inputted surround sound signals and monaural signal and outputs signals of thus generated reverb components to the output divider 360, the first output adder 370, and the second output adder 380. For example, each of the reverb generation circuit for surround sound signal 350 generates a reverb component of attenuating by 8 dB every 20 msec as shown in FIG. 7.

The output divider 360 inputs the monaural signal generates as the reverb component. The output divider 360 divides the inputted monaural signal to two systems and outputs these to the first input adder 370 and the second output adder 380.

The first output adder 370 inputs the surround sound signal generated as the reverb component (hereinafter referred to as a reverb surround sound signal), the surround sound signal maintaining the original component (hereinafter referred to as a basic surround sound signal), and the monaural signal which is generated as the reverb signal. Further, the first output adder 370 continues to adjust the inputted signals to be at a predetermined signal level and adds the signals to thereby generate a surround sound signal having a reverb component and a monaural signal component (hereinafter referred to as a processed surround sound signal). The processed surround sound signal is outputted to the frequency characteristics correction circuit 123.

For example, the first output adder 370 according to this embodiment adjusts a standard surround sound signal to a level of 0.5 times of the signal level of the surround sound signal when inputted into the surround sound signal processing unit 300, and the reverb surround sound signal and the monaural signal are adjusted to be 0.2 times of the signal level of the surround sound signal when inputted into the surround sound signal processing unit 300, and thus the processed surround sound signal is generated.

Since the second output adder 380 treats a different surround sound signal and the structure is the same, the description is omitted.

As described, the surround sound system 200 according to the present invention has the structure including the signal processing device 220 which publicly addresses the speakers corresponding to the audio signals based on a plurality of the inputted audio signals to provide the sound space giving realistic sensations to the listener, the C speaker 131 which is arranged in the forward direction of the listener and publicly addresses the audio signal while positioning a the listener within the angle of sound spread, the FL speaker 132 and the FR speaker 133, and the SBL speaker 134 and the SBR speaker 135 which publicly address the audio signal to the wall surface of the sound space. The signal processing device 220 has the structure that includes the input processing unit 121 which inputs the main signal and the surround sound signal, the frequency characteristics correction circuit 123 which adjusts the frequency characteristics of the inputted surround sound signal based on the propagation circumstance at the time of publicly addressing the sound and adjusts the surround sound signal, the delay circuit 124 which adds the delay time corresponding to the surround sound signal to the inputted main signal, the electric power amplifier 126 which outputs the main signal added with the delay time to the C speaker 131, the FL speaker 132, and the FR speaker 133 and outputs the surround sound signal with its frequency adjusted to the SBL speaker 134 and the SBR speaker 135.

Accordingly, in this surround sound system 200, since it is possible to set the surround sound speakers 134 and 135 on the forward side of the listener, even when the surround sound speakers 134 and 135 are not set in the backward direction of the listener in the sound space, the surround sound speakers 134 and 135 can be used. Further, a connection code such as wire is not elongated by setting the surround sound speakers in the backward direction of the listener. Since the surround sound system 200 can provide a surround sound signal to the listener as an indirect sound and the main signal can be provided by delaying based on the indirect sound, the publicly addressed sound which is provided in the sound field space gives no feeling of strangeness and the realistic sensations are easily created, whereby a sound field space giving a sufficient feeling of spreading and deepening to the listener can be provided.

The surround sound system 200 according to this embodiment has a structure such that the surround sound signal processing unit 300 superposes a surround sound signal having a component other than the surround sound signals to be processed on each of the surround sound signals.

Accordingly, the surround sound system 200 can provide a sound field space which gives no feeling of strangeness in a publicly addressed sound and can easily create realistic sensation to thereby give a sufficient feeling of spreading and deepening to a listener by reducing non-correlation of the publicly addressed surround sound from the surround sound speakers 134 and 135 by adding a monaural signal to the surround sound signal which is publicly addressed from the surround sound speakers 134 and 135 for providing the surround effect to surfaces such as a ceiling surface and side wall surfaces and by spreading a directional perceptibility toward a back side of the listener.

Since in this embodiment, the surround sound signal processing unit 300 adds the reverb component to the surround sound signal and the monaural signal is simultaneously added or superposed, the processed surround sound signal may be generated by superposing the monaural signal on the surround sound signals, namely the standard surround sound signal without the reverb component added.

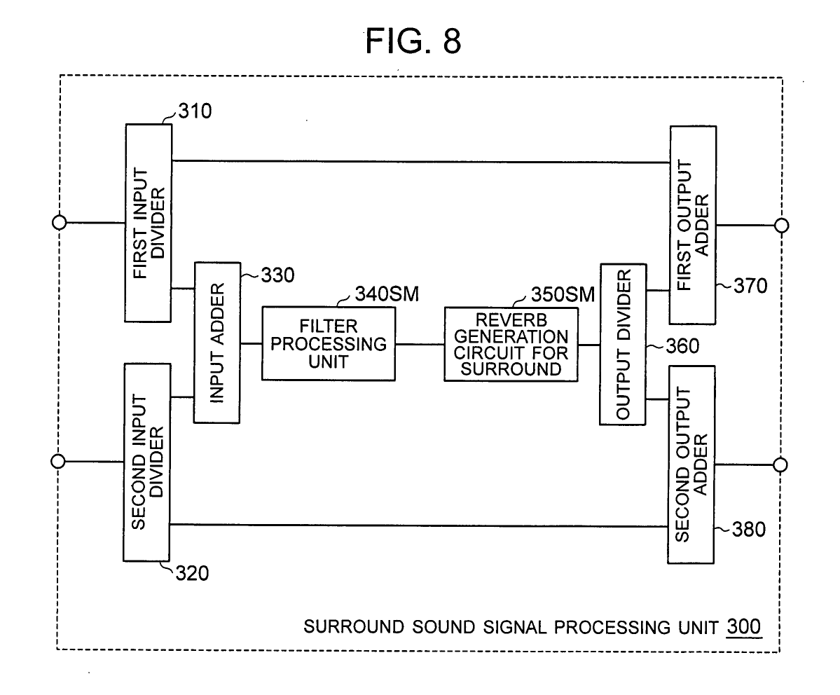

For example, in this case, the surround sound signal processing unit 300 including the first input divider 310, the second input divider 320, the input adder 330, the filter processing unit 340 which conducts the signal processing to the monaural signal, the reverb generation circuit for surround sound 350 which generates the reverb component based on the monaural signal subjected to the filter processing, the output divider 360, the first output adder 370, and the second output adder 380 may generate the processed surround sound signal by superposing the monaural signal obtained by adding the reverb to the standard surround sound signal. FIG. 8 is another example of the block chart showing the structure of the surround sound signal processing unit 300 according to this embodiment. In this case, the first output adder 370 and the second output adder 380 adjust the standard surround sound signal to a level of 0.5 times the signal level of the surround sound signal when it is inputted to the surround sound signal processing unit 300, and the monaural signal is adjusted to 0.3 times the signal level of the inputted surround sound signal.

Although, the delay circuit 124 is designed to add the predetermined delay time in this embodiment, the delay time which is set by a size of a sound field space, i.e. a size of a listening room 10, inputted by a listener through an operation unit, may be added to the various main signals and woofer signals.

In this case, the delay time corresponding to the size may be stored inside the delay circuit in advance.

Further, the surround sound system 200 reflects the publicly addressed sound from the surround sound speakers 134 and 135 on the side wall surfaces and the ceiling surface of the sound field space. It is also possible to let it reflect on the side wall surface and the ceiling surface of the sound field space and on the front wall surface of the listener.

### Embodiment 3

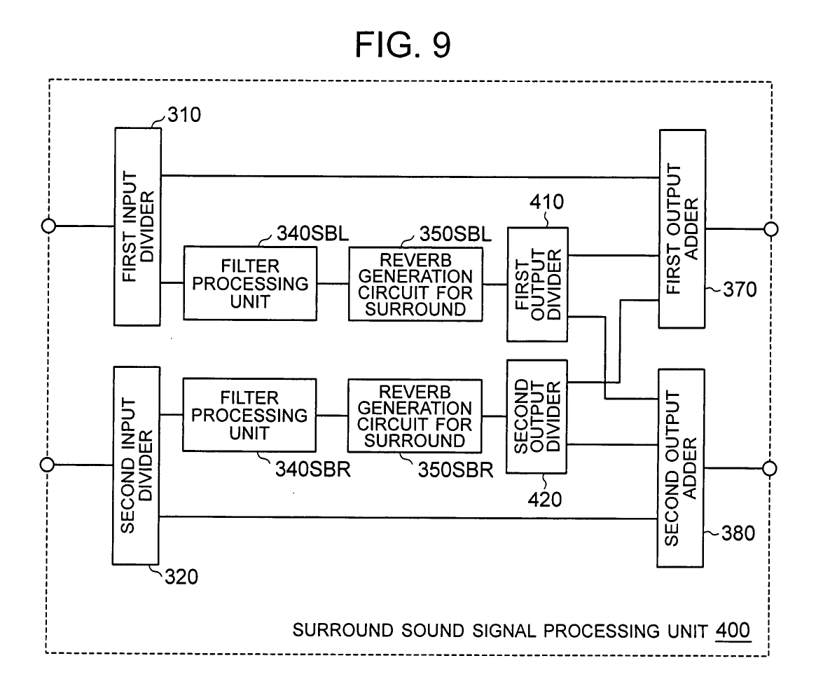

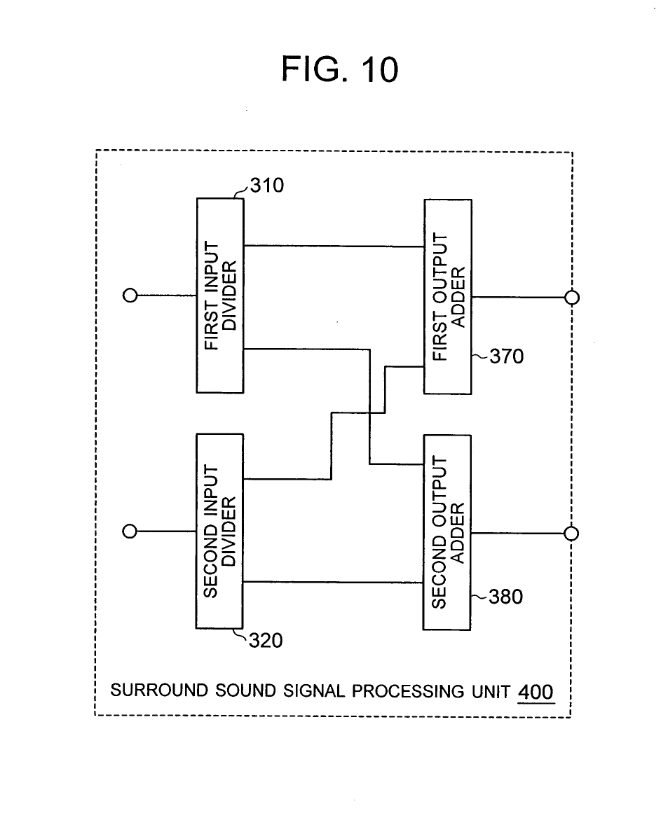

The surround sound system according to Embodiment 3 will be described in reference of FIGS. 9 and 10. This embodiment has a characteristic that surround sound signals are added to the other surround sound signals instead of conducting the signal processing of adding the reverb components to the surround sound signals as in Embodiment 2.

Specifically, in Embodiment 2, the directional perceptibility is spread to the back side of the listener by adding the monaural signal to the surround sound signal which is publicly addressed from the surround sound speakers to reduce the non-correlation of the publicly addressed sound from the surround sound speakers. However, in this embodiment, the reverb components are generated based on the surround sound signals, and the generated reverb components are respectively superposed to the other surround sound signal, i.e. surround sound signals which were not used for the generation of the reverb components. Thus the surround sound signals which are to be publicly addressed from the surround sound speakers are generated.

Although the other portion of the structure is the same as those of the Embodiment 2, the same numerical references are used for the same portions and description of these portions are omitted.

Now in reference of FIG. 9, a structure and an operation of a surround sound signal processing unit will be described in reference of FIG. 9. FIG. 9 is a block chart for showing the structure of the surround sound signal according to this embodiment.

The surround sound signal processing unit 400 according to this embodiment includes a first input divider 310 and a second input divider 320 which respectively distributes the inputted surround signals to a plurality of outputs, filter processing units 340 which conduct signal processing with respect to one of the divided surround sound signals, reverb generation circuits for surround sound 350 which generate a reverb component based on the signal with the filter processing done, a first output divider 410 and a second output divider 420 which respectively divide the signals generated as a reverb component, a first output adder 370 and a second output adder 380 which add the surround sound signals generated as the divided surround signal to the surround sound signal generated as the reverb component while adjusting the surround sound signals to be in a predetermined signal level.

The first input divider 310 inputs the surround sound signal which is outputted from the input processing unit 121 and publicly addressed by an SBL speaker 134. The first input divider 310 divides the inputted surround signals into two systems and output to the corresponding filter processing units 340 and the first output adder 370.

Because the second input divider 320 has the same structure as that of the first input divider 310 other than the surround sound signal to be processed, description of the second input divider 320 is omitted.

The first output divider 410 inputs the surround sound signal generated as the reverb component, and the first output divider 410 divides the inputted surround sound signal into two systems and outputs to the first output adder 370 and the second output adder 380.

Meanwhile, because the first output divider 420 is the same as the first output divider 410 other than the surround sound signal to be processed, a description of the first output divider is omitted.

The first output adder 370 inputs the reverb surround sound signal generated as the reverb component, a standard surround sound signal in which the original components which are outputted from the first input divider 310 is maintained, and the reverb surround sound signal generated as the reverb components on the basis of the other surround sound signals. The first output adder 370 adjusts the inputted signals to be a predetermined signal level and adds the inputted signals to generate a processed surround sound signal having the reverb component and the other surround sound signal components. The generated processed surround sound signal is outputted to the frequency characteristics correction circuit 123.

For example, the first output adder 370 adjusts the signal level of the surround sound signal to be 0.5 times the inputted sound signal at the time of inputting to the surround sound signal processing unit 400, and the reverb surround sound signal generated based on the same surround sound signal is adjusted to be 0.3 times the inputted surround sound signal at the time of inputting thereto. The reverb surround sound signal which is generated on the basis of the different surround sound signal is adjusted to be a level of 0.1 times the signal level at the time of inputting thereto and the processed surround sound signal is generated.

Because the structure of the second output adder 380 is the same as that of the first output adder 370 other than the surround sound signal to be processed, the description is omitted.

As described, the surround sound system according to this embodiment includes a signal processing unit 220 which publicly addresses from the speakers respectively corresponding to the audio signals based on the inputted plural audio signals and provides a listener with a sound field space giving realistic sensations, the C speaker 131, the FL speaker 132 and the FR speaker 133 which are positioned in the forward direction of the listener and publicly address the audio signals at a position of arranging the listener within the angle of sound spread, and the SBL speaker 134 and the SBR speaker 135 which are positioned in the forward direction of the listener and publicly address the audio signal toward the wall surfaces of the sound field space, wherein the signal processing unit 220 has a structure of including the input processing unit 121 to which the main signal and the surround sound signal are inputted, the frequency characteristics correction circuit 123 which adjusts the frequency characteristics of the inputted surround sound signal on the basis of a propagation circumstance at the time of publicly addressing the surround sound signal, the delay circuit 124 which adds a delay time corresponding to the surround sound signal to the inputted main signal, and the electric power amplifier 126 which outputs the main signals with the delay time added to the C speaker 131, the FL speaker 132, and the FR speaker 133 and outputs the surround sound signals with the frequency characteristics adjusted to the SBL speaker 134 and SBR speaker 135.

According to this structure, the surround sound system 200 according to this embodiment adds the delay time which occurs until the surround sound reaches the listener after the surround sound signal is publicly addressed to the main signal, and the main signal with the delay time added is outputted to the C speaker 131, the FL speaker 132, and the FR speaker 133 which are arranged in the forward direction of the listener and at the position of including the listener within the angle of sound spread. The frequency characteristics of the inputted surround sound signal is adjusted, and the surround sound signal with its frequency characteristics adjusted is outputted to the SBL speaker 134 and the SBR speaker 135 which are arranged in the forward direction of the listener and publicly address the sound toward the wall surfaces of the sound field space.

In the surround sound system 200, it is possible to set the surround sound speakers 134 and 135 on the front side of the listener. Even though the surround speakers 134 and 135 cannot be set in the backward direction of the listener, it is possible to use the surround sound speakers 134 and 135, and the connection code such as wiring is not elongated.

Further, the surround system 200 can provide the surround sound signal as an indirect sound and the main signal can be provided after delaying the main signal based on the indirect sound when the surround sound signal is provided as the indirect sound. Therefore, the publicly addressed sound presented to the sound field space does not give a feeling of strangeness to the listener and the sound field space which can create a sufficient feeling of spreading and deepening to the listener can be provided.

Further, the surround sound system 200 according to this embodiment has a structure that the surround sound processing unit 400 has the structure that the surround sound signal having a component different from those of the surround sound signals to be processed are superposed respectively to the surround sound signals to be processed.

Accordingly, since in the surround sound system 200 according to this embodiment, it is possible to reduce the non-correlation of the publicly addressed sound from the surround sound speakers 134 and 135 and to spread the directional perceptibility of the publicly addressed sound toward the back side of the listener by adding the monaural signals to the surround sound signals which are publicly addressed from the surround sound speakers 134 and 135 for providing with the surround effect toward the wall surfaces such as the ceiling surface and the side wall surfaces. Therefore, it is possible to provide a listener with a sound field space which does not cause a feeling of strangeness in a publicly addresses sound, realistic sensations which is easily obtainable, and a sufficient feeling of spreading and deepening.

Although in this embodiment the monaural signals are added to or superposed on the surround sound signals in the surround sound signal processing unit 400, it is also possible to superpose the other surround signals respectively on the surround sound signals without adding the reverb components to the standard surround sound signals to thereby generate the processed surround sound signals.

For example, in this case, the surround sound signal processing unit 400 includes a first input divider 310, a second input divider 320, first output adder 370, and a second output adder 380 to generate the processed surround sound signal by superposing the surround sound signals to the different surround sound signals. In this, FIG. 10 is another example of the block chart for showing the structure of the surround sound signal processing unit 400 according to this embodiment. In this case, the first output adder 370 and the second output adder 380 adjust the standard surround sound signal as a standard to be in a level of 0.85 times the signal level of the surround sound signals which are inputted into the surround sound signal processing unit 400, and the different surround sound signal is adjusted to be in a level of 0.15 times the signal level of the surround sound signal thus inputted.

Although the delay circuit 124 adds the predetermined delay time in this embodiment, it may possible to let a listener input the size of a sound field space, i.e. the listening room 10 through an operation unit and to add a delay time which is set based on the size of the inputted listening room to a main signal and a woofer signal.

In this case, the delay times corresponding to the sizes are stored inside the delay circuits in advance.

Further, the surround sound system 200 according to this embodiment reflects publicly addressed sounds which are publicly addressed from the surround sound speakers 134 and 135 are reflected on the side wall surfaces and the ceiling surface of the sound field space. However, it is of course possible to make the sound reflect on not only the side wall surfaces and the ceiling surface but also a wall surface in front of the listener.

The present invention is not confined to the configurations listed in the foregoing embodiments, but it is easily understood that the person skilled in the art can modify such configurations into various other modes, within the scope of the present invention described in the claims.

The entire disclosures of Japanese Patent Application No. 2004-60065 filed on Mar. 4, 2004 and Japanese Patent Application No. 2005-032641 filed on Feb. 9, 2005 including the specification, claims, drawings and summary are incorporated herein by reference in its entirety.

1. A stereophonic sound reproducing system comprising:
a stereophonic sound reproducing device which provides a sound field space to a listener by publicly addressing sounds from speakers corresponding to inputted plural sound signals on the basis of the inputted plural sound signals;
a main speaker which is arranged in a forward direction of the listener and publicly addresses the sound signal at a position which makes the listener include in an angle of sound spread; and
a surround speaker which is arranged in a forward direction of the listener and publicly addresses the sound signal toward wall surfaces of the sound field space, wherein
the stereophonic sound reproducing system includes:
a signal adjustment device which adjusts the surround signal by adjusting frequency characteristics of a surround sound signal which represents the sound signal which inputted so as to be publicly addressed from the surround speaker on the basis of a propagation circumstance at the time of public address;
a delay addition device which adds a delay corresponding to the surround sound signal which is publicly addressed from the surround speaker to a main signal representing the inputted sound signal which is publicly addressed from the main speaker; and
an output device which outputs the main signal with the delay added to the main speaker and outputs the surround sound signal with the frequency characteristics adjusted to the surround sound speaker.

2. A stereophonic sound reproducing system according to claim 1, wherein
the delay addition device adds the delay corresponding to a propagation route of the surround sound from the surround sound speaker through the wall surfaces to the listener at the time of publicly addressing the surround sound signal from the surround sound speaker.

3. A stereophonic sound reproducing system according to claim 1, wherein
the signal adjustment device adjusts the frequency characteristics of the surround sound signal on the basis of the propagation circumstance from the surround sound speaker through the wall surfaces to the listener at the time of publicly addressing the surround sound signal from the surround sound speaker.

4. A stereophonic sound reproducing system according to claim 1, wherein
the signal adjustment device adjusts the frequency characteristics of the frequency of the surround sound signal which is attenuated to be a predetermined level by reflection on the wall surfaces.

5. A stereophonic sound reproducing system according to claim 1, wherein
the signal adjustment device superposes a reverb sound component on the surround sound signal on the basis of the surround sound signal.

6. A stereophonic sound reproducing system according to claim 1, wherein
the surround sound speaker publicly addresses the surround sound signal toward at least anyone of a side surface, a front surface, and an upper surface with respect to the listener within the sound field space.

7. A stereophonic sound reproducing system according to claim 6, wherein
the number of the surround sound speakers is two and the surround sound speakers are respectively arranged on the right side and the left side with respect to the listener, and
the surround sound speakers publicly addresses respectively toward different surfaces of the side wall surfaces.

8. A stereophonic sound reproducing system according to claim 6, wherein
when the stereophonic sound reproducing device makes the plural surround sound speakers publicly address, and the surround sound signals are subjected to a predetermined processing respectively for the surround sound speakers, the signal adjustment device superposes at least any one of a surround sound signal having a component different from that of the surround sound signal to be adjusted and a surround sound signal for publicly addressing from the surround sound speaker which is different from the surround sound speaker to be adjusted respectively on the surround sound signals to be adjusted.

9. A stereophonic sound reproducing system according to claim 8, wherein
the signal adjustment device superposes at least any one of the surround sound signal having a component different from that of the surround sound signal to be adjusted and the surround sound signal for publicly addressing from the surround sound speaker which is different from the surround sound speaker to be adjusted on each of the surround sound signals to be adjusted while adjusting the frequency characteristics of the frequency in the surround sound signal to be attenuated to a predetermined level by the reflection on the wall surface.

10. A stereophonic sound reproducing system according to claim 8, wherein
the signal adjustment device superposes at least any one of the surround sound signal having a component different from that of the surround sound signal to be adjusted and the surround sound signal for publicly addressing from the surround sound speaker which is different from the surround sound speaker to be adjusted on each of the surround sound signals to be adjusted while adjusting at least one of the surround sound signal to be adjusted and the surround sound signal having a component different from that of the surround sound signals to be adjusted.

11. A stereophonic sound reproducing system according to claim 8, wherein
the signal adjustment device superposes at least any one of the surround sound signal having a component different from that of the surround sound signals to be adjusted and the surround sound signal for publicly addressing from the surround sound speaker which is different from the surround sound speaker to be adjusted on each of the surround sound signals to be adjusted while adding a reverb sound component on the basis of the surround sound signals.

12. A stereophonic sound reproducing system according to claim 8, wherein
the signal adjustment device superposes the surround sound signals which are generated by adding each of the surround sound signals respectively to the surround sound signals.

13. A stereophonic sound reproducing device for providing a sound field space giving realistic sensations to a listener by publicly addressing sounds from speakers corresponding to inputted plural sound signals on the basis of the inputted plural sound signals comprising, in publicly addressing from a main speaker which is arranged in a forward direction of the listener and publicly addresses the sound signal at a position which makes the listener include in an angle of sound spread and also from a surround speaker which is arranged in a forward direction of the listener and publicly addresses the sound signal toward wall surfaces of the sound field space:
a signal adjustment device which adjusts a surround sound signal by adjusting frequency characteristics of the surround sound signal which represents a sound signal inputted to be publicly addressed from the surround sound speaker on the basis of a propagation circumstance at the time of public address;
a delay time addition device which adds a delay time corresponding to the surround sound signal which is publicly addressed from the surround speaker to a main signal representing the inputted sound signal which is publicly addressed from the main speaker; and
an output device which outputs the main signal with the delay time added to the main speaker and outputs the surround sound signal with the frequency characteristics adjusted to the surround sound speaker.
